(19) United States
(12) Patent Application Publication
(10) Pub. No.: US 2023/0344677 A1
(43) Pub. Date: Oct. 26, 2023

(54) JOINT CHANNEL ESTIMATION FOR MULTIPLE DOWNLINK TRANSMISSIONS

(71) Applicant: Apple Inc., Cupertino, CA (US)

(72) Inventors: Chunxuan YE, San Diego, CA (US); Haitong SUN, Cupertino, CA (US); Hong HE, San Jose, CA (US); Yushu ZHANG, Beijing (CN); Wei ZENG, Saratoga, CA (US); Seyed Ali Akbar FAKOORIAN, San Diego, CA (US); Sigen YE, San Diego, CA (US); Chunhai YAO, Beijing (CN); Dawei ZHANG, Saratoga, CA (US); Weidong YANG, San Diego, CA (US)

(73) Assignee: Apple Inc., Cupertino, CA (US)

(21) Appl. No.: 18/129,672

(22) Filed: Mar. 31, 2023

Related U.S. Application Data
(60) Provisional application No. 63/334,916, filed on Apr. 26, 2022.

(51) Int. Cl. H04L 25/02; H04L 5/00; H04W 72/0446

(52) U.S. Cl. CPC H04L 25/0204; H04L 5/0051; H04W 72/0446

(57) ABSTRACT

Mechanisms are provided for a user equipment (UE) to perform joint channel estimation for multiple downlink transmissions. A method performed by a UE can include reporting, to a base station, a capability of the lIE to perform joint channel estimation, receiving a configuration for joint channel estimation, where the configuration includes a time domain window (TDW) indicating a duration of the joint channel estimation, and further determining whether to perform the joint channel estimation. Based on a determination to perform the joint channel estimation, the method can include determining an actual time domain window within the TDW for performing the joint channel estimation, and performing the joint channel estimation within the actual time domain window for a first physical downlink shared channel (PDSCH) transmission based on a first demodulation reference signals (DMRS), and a second PDSCH transmission based on a second DMRS.

### CROSS-REFERENCE TO RELATED APPLICATIONS

The present application claims the benefit of U.S. Provisional Pat. Application No. 63/334,916, filed on Apr. 26, 2022, which is hereby incorporated by reference in its entirety.

### FIELD

The described aspects generally relate to a wireless communication system, including joint channel estimation for multiple downlink transmissions.

### RELATED ART

A wireless communication system can include a fifth generation (5G) system, a New Radio (NR) system, a long term evolution (LTE) system, a non-terrestrial wireless network (NTN), a combination thereof, or some other wireless systems. In addition, a wireless communication system can support a wide range of use cases such as enhanced mobile broad band (eMBB), massive machine type communications (mMTC), ultra-reliable and low-latency communications (URLLC), enhanced vehicle to anything communications (eV2X), among others. Large propagation delays may become a problem for many wireless communication systems.

### SUMMARY

Some aspects of this disclosure relate to apparatuses and methods for implementing techniques for a user equipment (UE) to perform joint channel estimation for multiple downlink transmissions, such as multiple physical downlink shared channel (PDSCH) transmissions. Joint channel estimation for multiple PDSCH transmissions can improve the performance of decoding the received PDSCH transmissions to overcome challenges in a wireless network having a large propagation delay. The implemented techniques can be applicable to many wireless systems, e.g., a wireless communication system based on 3rd Generation Partnership Project (3GPP) release 15 (Rel-15), release 16 (Rel-16), release 17 (Rel-17), non-terrestrial wireless networks (NTN), or other wireless networks.

Some aspects of this disclosure relate to a UE. The UE can include a transceiver configured to enable wireless communication with a base station, and a processor communicatively coupled to the transceiver. The processor can be configured to report, to a base station, a capability of the UE to perform joint channel estimation for receiving a first PDSCH transmission and a second PDSCH transmission through a downlink between the base station and the UE, where the second PDSCH transmission can be a repetition of the first PDSCH transmission. The first PDSCH transmission can occur at a first slot, and the second PDSCH transmission can occur at a second slot. The capability of the UE can include a maximum number of slots for performing the joint channel estimation. The first PDSCH transmission can include at least a part of a first transport block (TB), and the second PDSCH transmission can include at least a part of a second TB different from the first TB. In some embodiments, the downlink from the base station can include a link from a satellite to the UE.

According to some aspects, the processor can be further configured to receive, from the base station, a configuration for joint channel estimation, where the configuration can be determined based on the reported capability of the UE, and the configuration can include a time domain window (TDW) indicating a duration of the joint channel estimation. In some embodiments, the configuration can include a time-domain resource allocation (TDRA) table having an indication of a number of repetitions of PDSCH transmissions including the first PDSCH transmission and the second PDSCH transmission.

According to some aspects, the processor can be further configured to determine whether to perform the joint channel estimation for the first PDSCH transmission and the second PDSCH transmission. In some embodiments, the processor can determine whether to perform the joint channel estimation based on whether receiving an indication from the base station to enable the UE to perform the joint channel estimation, or determining an indication for the UE to start performing the joint channel estimation.

According to some aspects, based on a determination to perform the joint channel estimation, the processor can be further configured to determine an actual time domain window within the TDW for performing the joint channel estimation for the first PDSCH transmission and the second PDSCH transmission. In some embodiments, the actual time domain window can be determined based on whether power consistency and phase continuity are satisfied within the TDW.

According to some aspects, the processor can be further configured to perform the joint channel estimation within the actual time domain window for the first PDSCH transmission and the second PDSCH transmission based on a first demodulation reference signals (DMRS) associated with the first PDSCH transmission and a second DMRS associated with the second PDSCH transmission. In some embodiments, the first DMRS can be same as the second DMRS or coherent with the second DMRS, and the first DMRS and the second DMRS form a DMRS bundling. The processor can be configured to receive a downlink control information (DCI) for scheduling the first PDSCH transmission and the second PDSCH transmission through the downlink, and further decode the first PDSCH transmission and the second PDSCH transmission based on the joint channel estimation performed based on the first DMRS and the second DMRS. In some embodiments, based on a determination of not to perform the joint channel estimation, the processor can be further configured to perform a channel estimation for the first PDSCH transmission based on the first DMRS, and perform a channel estimation for the second PDSCH transmission based on the second DMRS separate from the channel estimation for the first PDSCH.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a non-terrestrial wireless network (NTN) including a user equipment (UE) to perform joint channel estimation for multiple downlink transmissions, according to some aspects of the disclosure.

FIG. 2 illustrates a block diagram of a UE including a transceiver and a processor, according to some aspects of the disclosure.

FIG. 3 illustrates an example process performed by a UE to perform joint channel estimation for multiple downlink transmissions, according to some aspects of the disclosure.

FIGS. 4A-4C illustrate example processes performed by a UE to perform joint channel estimation for multiple downlink transmissions, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

With the development of mobile communication networks, for various reasons, some wireless systems, such as fifth-generation (5G) networks or non-terrestrial wireless networks, may have large propagation delay, higher propagation loss, weaker diffraction capability, and limited and shortened coverage. Non-terrestrial wireless networks (NTN) can refer to any network that involves non-terrestrial flying objects. An NTN can include a satellite communication network, a high altitude platform systems (HAPS), an air-to-ground network, a low-altitude unmanned aerial vehicles (UAVs, aka. drones), or any other NTN. Coverage enhancement technology may be needed to address the challenges in NTN or other similar networks with large propagation delay or other problems.

According to some aspects, in a conventional wireless system, uplink (UL) or downlink (DL) transmissions may be designed for a slot, which may be a dynamic scheduling unit or otherwise defined time duration by a communication standard. There is usually no consistency requirement or coordination in different multiple slots. One coverage enhancement technology to address the challenges due to the large propagation delay may coordinate over multiple slots for UL or DL transmissions, such as demodulation reference signal (DMRS) bundling of repeating a same DMRS or a coherent DMRS over multiple slots, multiple physical downlink shared channel (PDSCH) transmissions with repetitions, and joint channel estimations of multiple PDSCH transmissions.

According to some aspects, in a conventional wireless system, a channel estimation used for data demodulation is based on DMRS symbols in a slot. There is usually no consistency requirement for DMRS symbols in different slots or repeated transmission of DMRS symbols. With DMRS bundling technique, there can be additional DMRS symbols in a slot or multiple slots. The UE can send the same or coherent DMRS symbols in multiple slots, which may form a time domain window (TDW) that includes multiple physical uplink shared channel (PUSCH) transmissions or PDSCH transmissions. In some embodiments, a PDSCH transmission among a plurality of PDSCH transmissions can be referred as a PDSCH repetition as well when the content of the multiple PDSCH transmissions are the same. In some other embodiments, multiple PDSCH repetitions can refer to a different PDSCH transmission when the content of the multiple PDSCH repetitions are different, e.g., include contents from different TBs. The DMRS symbols sent in different slots may have power consistency and phase continuity, which is called DMRS bundling. Within a TDW, a UE may be expected to maintain power consistency and phase continuity among multiple PDSCH transmissions or repetitions so that DMRS bundling can be implemented.

In some embodiments, a UE can be configured to report, to a base station, a capability of the UE to perform joint channel estimation for receiving a first PDSCH transmission and a second PDSCH transmission through a downlink between the base station and the UE, where the second PDSCH transmission can be a repetition of the first PDSCH transmission. The UE can further receive, from the base station, a configuration for joint channel estimation, where the configuration can include a TDW indicating a duration of the joint channel estimation When the joint channel estimation is to be performed, the UE can determine an actual time domain window within the TDW for performing the joint channel estimation for the first PDSCH transmission and the second PDSCH transmission, further perform the joint channel estimation within the actual time domain window for the first PDSCH transmission and the second PDSCH transmission based on a first DMRS associated with the first PDSCH transmission and a second DMRS associated with the second PDSCH transmission.

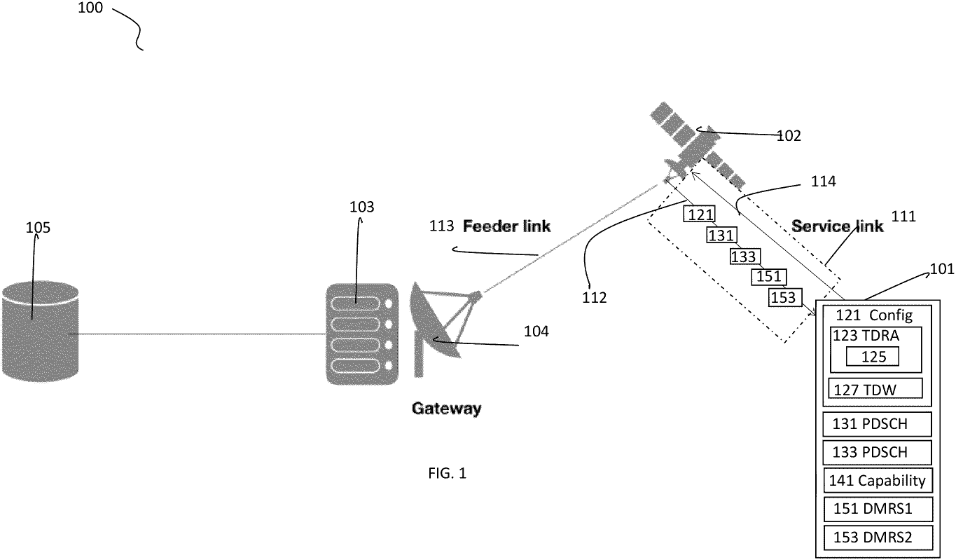

FIG. 1 illustrates an NTN 100 including a UE 101 to perform joint channel estimation for multiple downlink transmissions, according to some aspects of the disclosure. NTN 100 is provided for the purpose of illustration only and does not limit the disclosed aspects. Techniques described herein for NTN 100 can also be applicable to other wireless systems without a satellite for performing joint channel estimation for multiple downlink transmissions.

NTN 100 can include, but is not limited to, UE 101, a base station 103, a satellite 102, a gateway 104, and a core network 105. UE 101 communicates with satellite 102 through a service link 111, and satellite 102 communicates with gateway 104 through a feeder link 113. Service link 111 can include a downlink 112 and an uplink 114. Satellite 102 can include a network node or a transceiver for wireless communication. There can be various implementations of NTN 100. For example, base station 103 and gateway 104 may be integrated into one unit instead of being separated components. Base station 103 and core network 105 may implement functions as a normal terrestrial wireless network without a satellite, while gateway 104 may implementation functions between a terrestrial wireless network and satellite 102.

In some embodiments, NTN 100 can have a transparent payload, where base station 103 is located on the ground. In some embodiments, NTN 100 can have a regenerative payload when base station 103 can be located on satellite 102. There can be multiple satellites with onboard base stations communicating with each other. There can be other network entities, e.g., network controller, a relay station, not shown. AN NTN can be referred to as a wireless network, a wireless communication system, or some other names known to a person having ordinary skill in the art.

In some embodiments, NTN 100 can be an NTN having a non-terrestrial flying object, e.g., satellite 102. In some embodiments, NTN 100 can include a satellite communication network that includes satellite 102, a HAPS, or an air-to-ground network, or a UAV. There can be multiple satellites in NTN 100. Satellite 102 can be a low Earth orbiting (LEO) satellite, a medium Earth orbiting (MEO) satellite, or a geosynchronous (GSO) Earth orbiting (GEO) satellite. NTN 100 can be a HAPS, which can be an airborne platform including airplanes, balloons, and airships. For example, NTN 100 can include the International Mobile Telecommunications base stations, known as HIBS. A HIBS system can provides mobile service in the same transmission frequencys used by terrestrial mobile networks. NTN 100 can be an air-to-ground network to provide in-flight connectivity for airplanes by utilizing ground stations which play a similar role as base stations in terrestrial mobile networks. NTN 100 can also be a mobile enabled low-altitude UAVs.

In some embodiments, satellite 102 can be a GEO satellite deployed at an altitude of 35786 Km and is characterized by a slow motion around its orbital position with respect to a point on the Earth. Compared to terrestrial cellular systems, communication networks based on a GEO satellite have a large propagation delay that has to be taken into account in the overall design of the satellite network and high propagation losses. Additionally and alternatively, satellite 102 can be a LEO satellite at an altitude of 300-3000 km. In some embodiments, satellite 102 can communicate with UE 101 over various bands, such as 1610 - 1618.725 MHz UL (L-band) and 2483.5 - 2500 MHz DL (S-band). There can be power flux density (PFD) limitation on S-band. For example, for S-band 2483.5-2500 MHz DL for mobile-satellite services, a GSO satellite 102 can have a PFD: P = -146 dB (W/m²) in 4 kHz and -128 dB (W/m²) in 1 MHz, with r=0.5. In addition, a non-GSO satellite 102 can have a PFD: P=-144 dB (W/m²) in 4 kHz and -126 dB (W/m²) in 1 MHz, with r = 0.65.

According to some aspects, base station 103 can be a fixed station or a mobile station. In some embodiments, base station 103 can be located onboard satellite 102. Base station 103 can also be called other names, such as a base transceiver system (BTS), an access point (AP), a transmission/reception point (TRP), an evolved NodeB (eNB), a next generation node B (gNB), a 5G node B (NB), or some other equivalent terminology.

According to some aspects, UE 101 can be stationary or mobile. UE 101 can be a handheld terminal or a very small aperture terminal (VSAT) that is equipped with parabolic antennas and typically mounted on buildings or vehicles. UE 101 can be a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

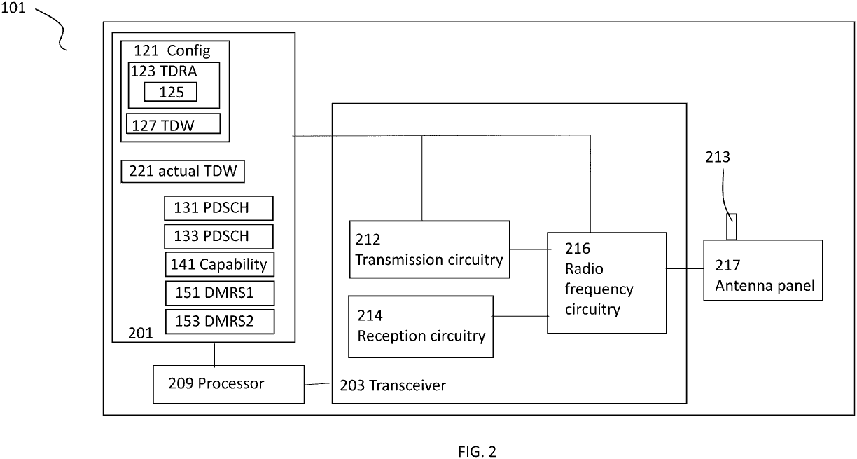

According to some aspects, UE 101 can be implemented according to a block diagram as illustrated in FIG. 2. Referring to FIG. 2, UE 101 can have antenna panel 217 including one or more antenna elements to form various transmission beams, e.g., transmission beam 213, coupled to a transceiver 203 and controlled by a processor 209. Transceiver 203 and antenna panel 217 (using transmission beam 213) can be configured to enable wireless communication in a wireless network. In detail, transceiver 203 can include radio frequency (RF) circuitry 216, transmission circuitry 212, and reception circuitry 214. RF circuitry 216 can include multiple parallel RF chains for one or more of transmit or receive functions, each connected to one or more antenna elements of the antenna panel. In addition, processor 209 can be communicatively coupled to a memory 201, which are further coupled to the transceiver 203. Various data can be stored in memory 201.

In some embodiments, memory 201 can store a capability 141 of UE 101 to perform joint channel estimation. UE 101 can receive from base station 103 a configuration 121 for joint channel estimation, which is stored in memory 201. Configuration 121 can include a TDW 127 indicating a duration of the joint channel estimation, and a time-domain resource allocation (TDRA) table 123 having an indication 125 of a number of repetitions of PDSCH transmissions including a first PDSCH transmission and a second PDSCH transmission. UE 101 can receive a first PDSCH transmission 131 and a second PDSCH transmission 133, which can be saved into memory 201. UE 101 can receive a first DMRS 151 associated with the first PDSCH transmission 131 and a second DMRS 153 associated with the second PDSCH transmission 133, which are saved in memory 201. Memory 201 can further store an actual time domain window 221, which is within the TDW 127, for performing the joint channel estimation for the first PDSCH transmission 131 and the second PDSCH transmission 133. In some embodiments, the first PDSCH transmission 131 occurs at a first slot, and the second PDSCH transmission 133 occurs at a second slot.

In some embodiments, a slot can be used as a dynamic scheduling unit. Additionally, some wireless system may support transmission based on mini-slot (a fraction of a slot) as a minimum scheduling unit. The number of OFDM symbols per slot can be fixed, such as 14 with normal cyclic prefix (CP) and 12 with extended CP. In LTE, the number of slots per subframe can be fixed at 2. In NR, the number of slots per subframe varies with numerology (increasing with subcarrier spacing). In some embodiments, a slot can have a length or duration as 0.5 ms, while some subframe can have a length or duration as 1 ms. A slot can be classified as downlink (all symbols are dedicated for downlink) or uplink (all symbols are dedicated for uplink) or mixed uplink and downlink transmissions.

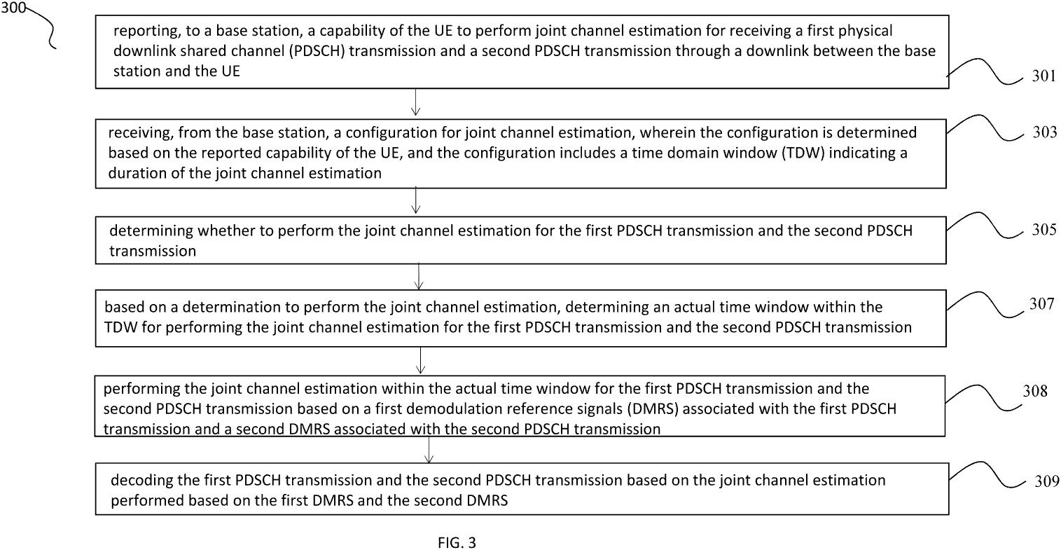

In some embodiments, memory 201 can include instructions, that when executed by the processor 209 perform operations described herein, e.g., operations described in process 300 in FIG. 3 by a UE for performing joint channel estimation for multiple downlink transmissions. Alternatively, processor 209 can be “hard-coded” to receive PDSCH transmissions of a TB over multiple slots described herein.

FIG. 3 illustrates an example process 300 performed by a UE for performing joint channel estimation for multiple downlink transmissions, according to some aspects of the disclosure. According to some aspects, as shown in FIG. 3, process 300 can be performed by UE 101.

At 301, UE 101 can report, to base station 103, a capability 141 of UE 101 to perform joint channel estimation for receiving the first PDSCH transmission 131 and the second PDSCH transmission 133 through a downlink between base station 103 and UE 101, where the second PDSCH transmission 133 can be a repetition of the first PDSCH transmission 131. In some embodiments, the downlink from the base station can include a link from a satellite to the UE. The capability 141 of UE 101 can include a maximum number of slots for performing the joint channel estimation. In some embodiments, the first PDSCH transmission 131 can include at least a part of a first transport block (TB), and the second PDSCH transmission 133 can include at least a part of a second TB different from the first TB.

At 303, UE 101 can receive, from base station 103, configuration 121 for joint channel estimation, where configuration 121 can be determined based on the reported capability 141 of UE 101, and configuration 121 can include a TDW 127 indicating a duration of the joint channel estimation. In some embodiments, configuration 121 can include TDRA table 123 having the indication 125 of a number of repetitions of PDSCH transmissions including the first PDSCH transmission 131 and the second PDSCH transmission 133.

At 305, UE 101 can determine whether to perform the joint channel estimation for the first PDSCH transmission 131 and the second PDSCH transmission 133. UE 101 can make such a determination based on the reported capability 141 of UE 101. In some embodiments, UE 101 can determine whether to perform the joint channel estimation based on whether receiving an indication from the base station to enable UE 101 to perform the joint channel estimation, or determining an indication for the UE to start performing the joint channel estimation.

At 307, based on a determination to perform the joint channel estimation, UE 101 can determine the actual TDW 221 within the TDW 127 for performing the joint channel estimation for the first PDSCH transmission 131 and the second PDSCH transmission 133. In some embodiments, the actual TDW 221 can be determined based on whether power consistency and phase continuity are satisfied within the TDW 127. The actual TDW 221 may be smaller than the TDW 127. TDW 127 is determined by base station 103, while the actual TDW 221 is determined by UE 101 based on what is available or some other parameters in addition the TDW 127 determined by base station 103.

At 308, UE 101 can perform the joint channel estimation within the actual TDW 221 for the first PDSCH transmission 131 and the second PDSCH transmission 133 based on a first DMRS 151 associated with the first PDSCH transmission 131 and the second DMRS 153 associated with the second PDSCH transmission 133. In some embodiments, the first DMRS 151 can be the same as the second DMRS 153 or coherent with the second DMRS 153, and the first DMRS 151 and the second DMRS 153 can form a DMRS bundling. UE 101 can further receive a downlink control information (DCI) for scheduling the first PDSCH transmission 131 and the second PDSCH transmission 133 through the downlink.

At 309, UE 101 can decode the first PDSCH transmission 131 and the second PDSCH transmission 133 based on the joint channel estimation performed based on the first DMRS 151 and the second DMRS 153. In some embodiments, based on a determination of not to perform the joint channel estimation, UE 101 can perform a channel estimation for the first PDSCH transmission 131 based on the first DMRS 151, and perform a channel estimation for the second PDSCH transmission 133 based on the second DMRS 153 separate from the channel estimation for the first PDSCH 131.

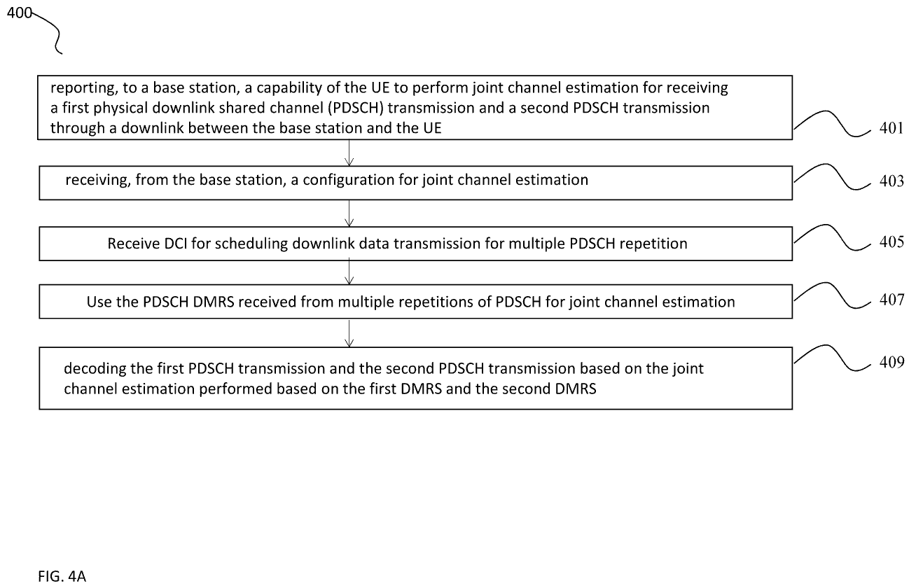

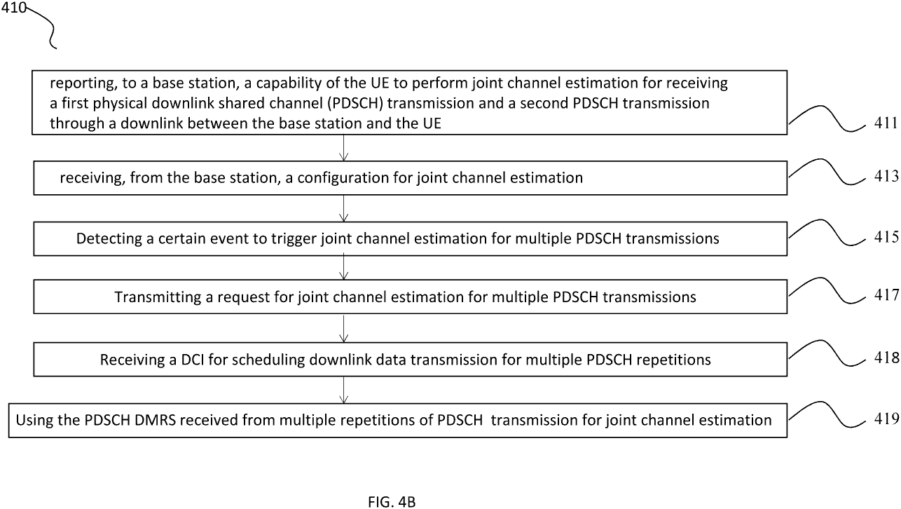

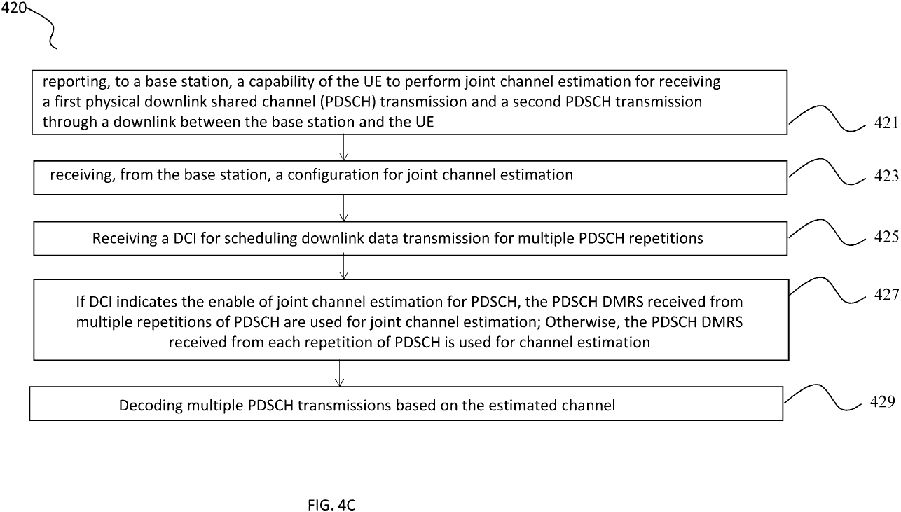

FIGS. 4A-4C illustrate example processes, e.g., process 400, process 410, and process 420, performed by a UE for performing joint channel estimation for multiple downlink transmissions, according to some aspects of the disclosure. Process 400, process 410, and process 420 can be examples of process 300, illustrated with more, less, or different details.

Process 400 is shown in FIG. 4A as a process without showing a determination whether to perform the joint channel estimation as shown in FIG. 3, step 305, while provide some more details for other steps of process 300.

At 401, UE 101 can report, to base station 103, a capability 141 of UE 101 to perform joint channel estimation for receiving the first PDSCH transmission 131 and the second PDSCH transmission 133 through a downlink between base station 103 and UE 101. UE 101 may report the maximum duration over which it can perform joint channel estimation for multiple PDSCH transmissions. If UE 101 reports that UE 101 does not have the capability of joint channel estimation for multiple PDSCH transmissions, UE 101 may not expect to receive a configuration related to joint channel estimation.

In some embodiments, the first PDSCH transmission 131 and the second PDSCH transmission 133 may be back-to-back (consecutive) PDSCH transmissions across consecutive slots, which may happen when PDSCH aggregation factor is greater than 1, or transport blocks (TBs) is transmitted over multiple slots (TBoMS) for PDSCH transmissions. In some other embodiments, when PDSCH repetition type B (slot-based repetition) is introduced or supported, the first PDSCH transmission 131 and the second PDSCH transmission 133 may be back-to-back or consecutive PDSCH transmissions within a slot. In some other embodiments, the first PDSCH transmission 131 and the second PDSCH transmission 133 may be non-back-to-back (not consecutive) PDSCH transmissions across consecutive slots when the phase continuity and power consistency are maintained. In addition, the first PDSCH transmission 131 and the second PDSCH transmission 133 may be a part of a same TB, or a part of different TBs. Accordingly, the first PDSCH transmission 131 can include at least a part of a first TB, and the second PDSCH transmission 133 can include at least a part of a second TB different from the first TB.

At 403, UE 101 can receive, from base station 103, configuration 121 for joint channel estimation, where configuration 121 can be determined based on the reported capability 141 of UE 101, and configuration 121 can include TDW 127 indicating a duration of the joint channel estimation. In some embodiments, configuration 121 can include TDRA table 123 having the indication 125 of a number of repetitions of PDSCH transmissions including the first PDSCH transmission 131 and the second PDSCH transmission 133. TDRA table 123 can have an optional field of “repetition number” to be the indication 125 of a number of repetitions of PDSCH transmissions. In some embodiment, configuration may include a PDSCH configuration with aggregation factor > 1.

In some embodiments, UE 101 may be expected to perform joint channel estimation in TDW 127, where base station 103 may maintain power consistency and phase continuity among multiple PDSCH transmissions. UE 101 can perform joint channel estimation of multiple PDSCH transmissions over a maximum number of slots (K). The maximum number of slots (K) may be related to UE capability. The maximum value of window length L of TDW 127, if configured, may not exceed the maximum duration reported by UE capability. If L is not configured, L may have a default value L= min(K, duration of all PDSCH repetitions).

In some embodiments, one or multiple actual TDWs can be implicitly determined within one configured TDW, e.g., TDW 127. If power consistency and phase continuity are violated within TDW 127 due to an event, whether an actual TDW may be created is subject to UE capability of supporting restarting DMRS bundling. TDW 127 can be defined based on physical slots or based on available slots. In some embodiments, events that can violate power consistency and phase continuity within TDW 127 may include: a slot being dropped or cancelled based on Rel-15/16 collision rules, a slot being used as a UL slot or UL reception/monitoring based on semi-static DL/LTL configuration for unpaired spectrum, a gap between two PDSCH transmissions exceeding X symbols for a predefined or configured X based on UE capability reporting, or DL receiver beam switching for multi-Transmission/Reception Point (TRP) operation if DMRS bundling and DL receiver beam switching are configured simultaneously.

At 405, UE 101 can receive a DCI for scheduling downlink data transmission for multiple PDSCH transmissions such as the first PDSCH transmission 131 and the second PDSCH transmission 133. DCI is used as an example for scheduling downlink data transmission. In some embodiments, the downlink data transmission for multiple PDSCH transmissions can be scheduled by a physical downlink control channel (PDCCH). When one PDCCH schedules multiple PDSCH transmissions, each PDSCH transmission can have the same frequency domain location and modulation and coding scheme (MCS) and TBs. The number of consecutive slots used for the multiple PDSCH transmissions can be indicated by the PDCCH for scheduling the PDSCH transmissions. In some embodiments, there can be some restrictions on the joint channel estimation of multiple PDSCH transmissions of different TBs. Such restrictions may include: the modulation order for the PDSCH transmissions may be Quadrature Phase Shift Keying (QPSK) or lower modulation order; frequency location of multiple PDSCH transmissions for different TBs may have a small offset. For example, same frequency location may be used for multiple PDSCH transmissions of different TBs, a frequency offset may be smaller than a configured threshold, a time gap of for multiple PDSCH transmissions for different TBs may be smaller than a configured threshold, or a total duration of multiple PDSCH transmissions for different TBS may be smaller than UE reported capability of maximum duration.

At 407, UE 101 can use the PDSCH DMRS received from multiple repetitions of PDSCH (for the same TB) for joint channel estimation. UE 101 can perform the joint channel estimation within the actual TDW 221 for the first PDSCH transmission 131 and the second PDSCH transmission 133 based on a first DMRS 151 associated with the first PDSCH transmission 131 and the second DMRS 153 associated with the second PDSCH transmission 133.

At 409, UE 101 can decode the first PDSCH transmission 131 and the second PDSCH transmission 133 based on the joint channel estimation performed based on the first DMRS 151 and the second DMRS 153.

Process 410 is shown in FIG. 4B, where process 410 includes triggering of joint channel estimation and TBoMS for multiple PDSCH transmissions. In addition, a request for joint channel estimation may be sent, which is not included in process 300.

At 411, UE 101 can report, to base station 103, capability 141 of UE 101 to perform joint channel estimation for receiving the first PDSCH transmission 131 and the second PDSCH transmission 133 through a downlink between base station 103 and UE 101.

At 413, UE 101 can receive, from base station 103, configuration 121 for joint channel estimation, where configuration 121 can be determined based on the reported capability 141 of UE 101, and configuration 121 can include a TDW 127 indicating a duration of the joint channel estimation. In some embodiments, configuration 121 can include TDRA table 123 having the indication 125 of a number of repetitions of PDSCH transmissions including the first PDSCH transmission 131 and the second PDSCH transmission 133.

At 415, UE 101 can detect a certain event to trigger joint channel estimation for multiple PDSCH transmissions. At 417, UE 101 can transmit a request for joint channel estimation for multiple PDSCH transmissions to base station 103.

In some embodiments, UE 101 can trigger joint channel estimation. If a hypothesis Block Error Rate (BLER) is below a threshold, UE 101 can trigger a request for joint channel estimation, where the BLER is measured based on either PDCCH or PDSCH, and the threshold may be configured by base station 103. In some embodiments, if the signal interference noise ratio (SINR), synchronization signal reference signal received power (SS RSRP), or Channel State Information reference signal received power (CSI RSRP) is below a threshold, UE 101 can trigger a request for joint channel estimation, where SINR can be measured based on either PDCCH or PDSCH, and the threshold may be configured. In some embodiments, if UE 101 experiences a certain number of consecutive PDSCH decoding errors, UE 101 can trigger a request for joint channel estimation. The certain number of errors may be configured or pre-defined. In some embodiments, if UE specific time advance (TA), or UE full TA, is larger than a configured threshold, UE 101 can trigger a request for joint channel estimation. The triggering signaling may be carried by Medium Access Control (MAC) Control Element, RRC, or PUCCH.

In some embodiments, base station 103 can trigger the joint channel estimation depending on UE capability reporting, or UE specific Koffset. If UE specific Koffset is larger than a threshold, base station 103 can trigger joint channel estimation. In some other embodiments, if UE 101 reports a channel quality indicator (CQI) that is less than a threshold, base station 103 can trigger joint channel estimation.

At 418, UE 101 can receive a DCI for scheduling downlink data transmission for multiple PDSCH repetitions such as the first PDSCH transmission 131 and the second PDSCH transmission 133.

At 419, UE 101 can use the PDSCH DMRS received from multiple repetitions of PDSCH transmissions (for the same TB) for joint channel estimation. UE 101 can perform the joint channel estimation within the actual TDW 221 for the first PDSCH transmission 131 and the second PDSCH transmission 133 based on a first DMRS 151 associated with the first PDSCH transmission 131 and the second DMRS 153 associated with the second PDSCH transmission 133. In addition, UE 101 can decode the first PDSCH transmission 131 and the second PDSCH transmission 133 based on the joint channel estimation performed based on the first DMRS 151 and the second DMRS 153.

Process 420 is shown in FIG. 4C, where process 420 can include performing joint channel estimation for multiple downlink transmissions based on an additional enabling signal received from the base station.

At 421, UE 101 can report, to base station 103, a capability 141 of UE 101 to perform joint channel estimation for receiving the first PDSCH transmission 131 and the second PDSCH transmission 133 through a downlink between base station 103 and UE 101.

At 423, UE 101 can receive, from base station 103, configuration 121 for joint channel estimation, where configuration 121 can be determined based on the reported capability 141 of UE 101, and configuration 121 can include a TDW 127 indicating a duration of the joint channel estimation. In some embodiments, configuration 121 can include TDRA table 123 having the indication 125 of a number of repetitions of PDSCH transmissions including the first PDSCH transmission 131 and the second PDSCH transmission 133.

At 425, UE 101 can receive DCI for scheduling downlink data transmission for multiple PDSCH repetitions such as the first PDSCH transmission 131 and the second PDSCH transmission 133.

At 427, if the received DCI indicates to enable joint channel estimation for multiple PDSCH transmissions, the PDSCH DMRS received from multiple repetitions of multiple PDSCH transmissions are used for joint channel estimation; otherwise, the PDSCH DMRS received from each repetition of PDSCH is used for channel estimation. In some embodiments, a signal for enabling/disabling joint channel estimation for multiple repetitions of PDSCH can be carried via RRC signaling. In some embodiments, a new RRC parameter can be defined to enable/disable joint channel estimation or the parameter enable/disable DRMS bundling and TDW jointly. In some embodiments, a signal for enabling/disabling joint channel estimation for multiple repetitions of PDSCH can be carried by PDSCH or TDRA table configuration and explicit DCI activation. If the TDRA table entries are not configured with “repetition number” and PDSCH is configured with aggregation factor = 1, then joint channel estimation is disabled. If the TDRA table entries are configured with “repetition number”, DCI (e.g., formats 1_1, 1_2) may additionally indicate whether joint channel estimation is activated or not. In some embodiments, an additional bit in DCI to indicate the activation of joint channel estimation. In some other embodiments, a code point of an existing DCI field (e.g., FDRA field) to indicate the activation of joint channel estimation. If TDRA table entries are not configured with “repetition number”, but PDSCH is configured with aggregation factor >1, DCI (e.g., formats 1_1, 1_2) may additionally indicate whether joint channel estimation is activated or not. By explicit indication from the DCI, base station 103 can ensure the phase continuity and power consistency in PDSCH repetitions. Otherwise, UE 101 does not expect phase continuity and power consistency in PDSCH repetitions.

In some embodiments, during the joint channel estimation for PDSCH, UE 101 may meet some conditions, such as modulation order does not change, resource block (RB) allocation in terms of length and frequency position does not change, transmission power does not change, or phase continuity between the transmissions is maintained.

At 429, UE 101 can decode the first PDSCH transmission 131 and the second PDSCH transmission 133 based on the joint channel estimation performed based on the first DMRS 151 and the second DMRS 153.

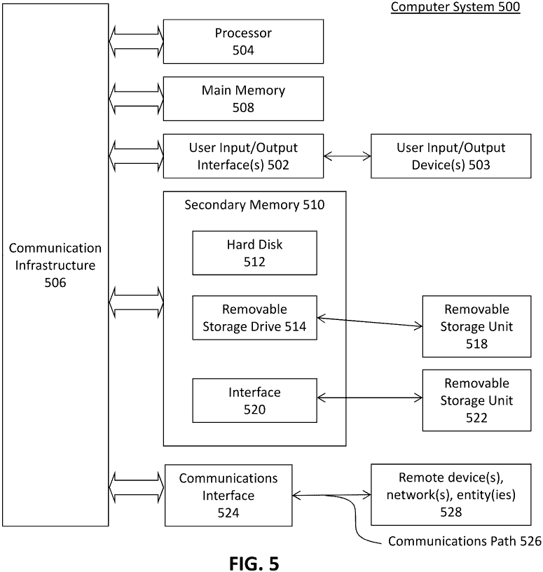

Various aspects can be implemented, for example, using one or more computer systems, such as computer system 500 shown in FIG. 5. Computer system 500 can be any computer capable of performing the functions described herein such as UE 101, or base station 103 as shown in FIG. 1 and FIG. 2, for operations described for processor 209 or process 300, process 400, process 410, or process 420 as shown in FIGS. 3, 4A-4C. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/ any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, or base station 103 as shown in FIG. 1 and FIG. 2. In some examples, the operations include those operations illustrated and described for process 300, process 400, process 410, or process 420 as shown in FIGS. 3, 4A-4C.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of performing wireless communication by a user equipment (UE), comprising:
reporting, to a base station, a capability of the UE to perform joint channel estimation for receiving a first physical downlink shared channel (PDSCH) transmission and a second PDSCH transmission through a downlink between the base station and the UE, wherein the second PDSCH transmission is a repetition of the first PDSCH transmission;
receiving, from the base station, a configuration for joint channel estimation, wherein the configuration is determined based on the reported capability of the UE, and the configuration includes a time domain window (TDW) indicating a duration of the joint channel estimation,
determining whether to perform the joint channel estimation for the first PDSCH transmission and the second PDSCH transmission;
based on a determination to perform the joint channel estimation, determining an actual time domain window within the TDW for performing the joint channel estimation for the first PDSCH transmission and the second PDSCH transmission;
performing the joint channel estimation within the actual time domain window for the first PDSCH transmission and the second PDSCH transmission based on a first demodulation reference signals (DMRS) associated with the first PDSCH transmission and a second DMRS associated with the second PDSCH transmission; and
decoding the first PDSCH transmission and the second PDSCH transmission based on the joint channel estimation performed based on the first DMRS and the second DMRS.

2. The method of claim 1,further comprising:
receiving a downlink control information (DCI) for scheduling the first PDSCH transmission and the second PDSCH transmission through the downlink.

3. The method of claim 1, wherein the downlink from the base station includes a link from a satellite to the UE.

4. The method of claim 1, wherein the first DMRS is same as the second DMRS or is coherent with the second DMRS, and the first DMRS and the second DMRS form a DMRS bundling.

5. The method of claim 1, wherein the first PDSCH transmission occurs at a first slot, and the second PDSCH transmission occurs at a second slot.

6. The method of claim 1, wherein the capability of the UE includes a maximum number of slots for performing the joint channel estimation.

7. The method of claim 1, wherein the configuration includes a time-domain resource allocation (TDRA) table having an indication of a number of repetitions of PDSCH transmissions including the first PDSCH transmission and the second PDSCH transmission.

8. The method of claim 1, wherein the determining whether to perform the joint channel estimation comprises receiving an indication from the base station to enable the UE to perform the joint channel estimation.

9. The method of claim 1, wherein the determining whether to perform the joint channel estimation comprises determining an indication from the UE to start performing the joint channel estimation.

10. The method of claim 1, wherein based on a determination of not to perform the joint channel estimation, performing a channel estimation for the first PDSCH transmission based on the first DMRS, and performing a channel estimation for the second PDSCH transmission based on the second DMRS separate from the channel estimation for the first PDSCH.

11. The method of claim 1, wherein the determining the actual time domain window within the TDW comprises determining the actual time domain window based on whether power consistency and phase continuity are satisfied within the TDW.

12. The method of claim 1, wherein the first PDSCH transmission includes at least a part of a first transport block (TB), and the second PDSCH transmission includes at least a part of a second TB different from the first TB.

13. A user equipment (UE), comprising:
a transceiver configured to enable wireless communication over a wireless network with a base station; and
a processor communicatively coupled to the transceiver and configured to:
report, to the base station, a capability of the UE to perform joint channel estimation for receiving a first physical downlink shared channel (PDSCH) transmission and a second PDSCH transmission through a downlink between the base station and the UE, wherein the second PDSCH transmission is a repetition of the first PDSCH transmission;
receive, from the base station, a configuration for joint channel estimation, wherein the configuration is determined based on the reported capability of the UE, and the configuration includes a time domain window (TDW) indicating a duration of the joint channel estimation;
determine whether to perform the joint channel estimation for the first PDSCH transmission and the second PDSCH transmission;
based on a determination to perform the joint channel estimation, determining an actual time domain window within the TDW for performing the joint channel estimation for the first PDSCH transmission and the second PDSCH transmission;
perform the joint channel estimation within the actual time domain window for the first PDSCH transmission and the second PDSCH transmission based on a first demodulation reference signals (DMRS) associated with the first PDSCH transmission and a second DMRS associated with the second PDSCH transmission; and
decode the first PDSCH transmission and the second PDSCH transmission based on the joint channel estimation performed based on the first DMRS and the second DMRS.

14. The UE of claim 13, wherein the processor is further configured to:
receive a downlink control information (DCI) for scheduling the first PDSCH transmission and the second PDSCH transmission through the downlink.

15. The UE of claim 13, wherein the downlink from the base station includes a link from a satellite to the UE.

16. The UE of claim 13, wherein the first DMRS is same as the second DMRS or is coherent with the second DMRS, and the first DMRS and the second DMRS form a DMRS bundling.

17. The UE of claim 13, wherein the first PDSCH transmission occurs at a first slot, and the second PDSCH transmission occurs at a second slot.

18. The UE of claim 13, wherein the capability of the UE includes a maximum number of slots for performing the joint channel estimation.

19. A non-transitory computer-readable medium storing instructions that, when executed by a processor of a user equipment (UE), cause the UE to perform operations, the operations comprising:
reporting, to a base station, a capability of the UE to perform joint channel estimation for receiving a first physical downlink shared channel (PDSCH) transmission and a second PDSCH transmission through a downlink between the base station and the UE, wherein the second PDSCH transmission is a repetition of the first PDSCH transmission;
receiving, from the base station, a configuration for joint channel estimation, wherein the configuration is determined based on the reported capability of the UE, and the configuration includes a time domain window (TDW) indicating a duration of the joint channel estimation;
determining whether to perform the joint channel estimation for the first PDSCH transmission and the second PDSCH transmission;
based on a determination to perform the joint channel estimation, determining an actual time domain window within the TDW for performing the joint channel estimation for the first PDSCH transmission and the second PDSCH transmission;
performing the joint channel estimation within the actual time domain window for the first PDSCH transmission and the second PDSCH transmission based on a first demodulation reference signals (DMRS) associated with the first PDSCH transmission and a second DMRS associated with the second PDSCH transmission; and
decoding the first PDSCH transmission and the second PDSCH transmission based on the joint channel estimation performed based on the first DMRS and the second DMRS.

20. The non-transitory computer-readable medium of claim 19, wherein the first DMRS is same as the second DMRS or is coherent with the second DMRS, and the first DMRS and the second DMRS form a DMRS bundling.
